(19) United States
(12) Patent Application Publication
(10) Pub. No.: US 2012/0249384 A1
(43) Pub. Date: Oct. 4, 2012

(54) ANTENNA ARRANGEMENT AND A PORTABLE RADIO COMMUNICATION DEVICE COMPRISING SUCH AN ANTENNA ARRANGEMENT

(76) Inventors: Andrei Kaikkonen, Jarfalla (SE); Teresa Meier, Graz (AT); Peter Lindberg, Uppsala (SE); Stefan Irmscher, Taby (SE)

(21) Appl. No.: 13/525,661

(22) Filed: Jun. 18, 2012

Related U.S. Application Data
(63) Continuation of application No. PCT/SE2010/051331, filed on Dec. 2, 2010.

(30) Foreign Application Priority Data
Dec. 18, 2009 (EP) 09179830.6

(51) Int. Cl. H01Q 5/00

(52) U.S. Cl. 343/722

(57) ABSTRACT

An exemplary embodiment includes an antenna arrangement for a portable radio communication device comprising an NFC (near field communication) antenna, a BT (Bluetooth) antenna and an FM (frequency modulation) antenna. The NFC antenna, BT antenna and FM antenna are positioned in close proximity to each other and are operable simultaneously. The NFC antenna is fed through a first decoupling filter and is grounded through a second decoupling filter.

### CROSS-REFERENCE TO RELATED APPLICATIONS

This application is a continuation of PCT International Patent Application No. PCT/SE2010/051331 filed Dec. 2, 2010, published as WO2011/075043, which, in turn, claims priority to European Patent Application No. 09179830.6 filed Dec. 18, 2009. The entire disclosure of the above applications are incorporated herein by reference.

### FIELD

The present disclosure relates to antenna arrangements for portable radio communication devices.

### BACKGROUND

This section provides background information related to the present disclosure which is not necessarily prior art.

Internal antennas have been used for some time in portable radio communication devices. There are a number of advantages connected with using internal antennas compared to protruding antennas. For example, internal antennas are small and light, making them suitable for applications wherein size and weight are of importance, such as in mobile phone, personal digital assistants (PDAs), portable computers, or similar devices.

But the application of internal antennas in a mobile phone puts some constraints on the configuration of the radiating element of the antenna. In particular, the space for an internal antenna arrangement is limited in a portable radio communication device. These constraints may make it difficult to find a configuration of the antenna arrangement that provides for desired use. This is especially true for antennas intended for use with radio signals of relatively low frequencies as the desired physical length of such antennas are large compared to antennas operating with relatively high frequencies.

One specific application operating in a relatively low frequency band is the FM (frequency modulation) radio application. The FM operating band is defined as frequencies between 88-108 Megahertz (MHz) in most of the world and frequencies between 76-90 MHz in Japan.

Further, a portable radio communication device is often provided with frequency operational coverage for other frequency bands than FM, such as NFC (near field communication), GSM900 (global system for mobile communications 900), GSM1800, GPS (global positioning system), BT (Bluetooth), WLAN (wireless local area network), and WCDMA (wideband code division multiple access). A portable radio communication device has limited space, and it is desirable, if possible, to add multiple functionality to an antenna arrangement. Further, all complementary antennas, such as non-cellular antennas, are typically allocated to a limited region of a mobile phone. Due to the close proximity of the antennas, isolation between the antennas will generally be a problem.

### SUMMARY

This section provides a general summary of the disclosure, and is not a comprehensive disclosure of its full scope or all of its features.

According to various aspects, exemplary embodiments are disclosed of antenna arrangements or antenna assemblies for portable radio communication devices. In an exemplary embodiment, an antenna arrangement or assembly generally includes an NFC (near field communication) antenna, a BT (Bluetooth) antenna and an FM (frequency modulation) antenna. The NFC antenna, BT antenna and FM antenna are positioned in close proximity to each other and are operable simultaneously. The NFC antenna is fed through a first decoupling filter and is grounded through a second decoupling filter.

In another exemplary embodiment, a portable radio communication device generally includes an NFC antenna, a BT antenna, and an FM antenna. The NFC antenna, the BT antenna, and the FM antenna are positioned in close proximity to each other and are operable simultaneously. The NFC antenna is fed through a first decoupling filter and is grounded through a second decoupling filter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic drawing illustrating an antenna arrangement according to a first exemplary embodiment.

FIG. 2 is a schematic drawing illustrating an alternative arrangement of the antenna arrangement illustrated in FIG. 1.

FIG. 3 is a schematic drawing illustrating an antenna arrangement according to a second exemplary embodiment.

FIG. 4 is a schematic drawing illustrating an antenna arrangement according to a third exemplary embodiment.

### DETAILED DESCRIPTION

Example embodiments will now be described more fully with reference to the accompanying drawings.

Exemplary embodiments are disclosed of antenna arrangements for portable radio communication devices that comprise an FM antenna, an NFC antenna, and a BT antenna for a portable radio communication device. The antennas are configured so as to occupy limited space of the portable radio communication device.

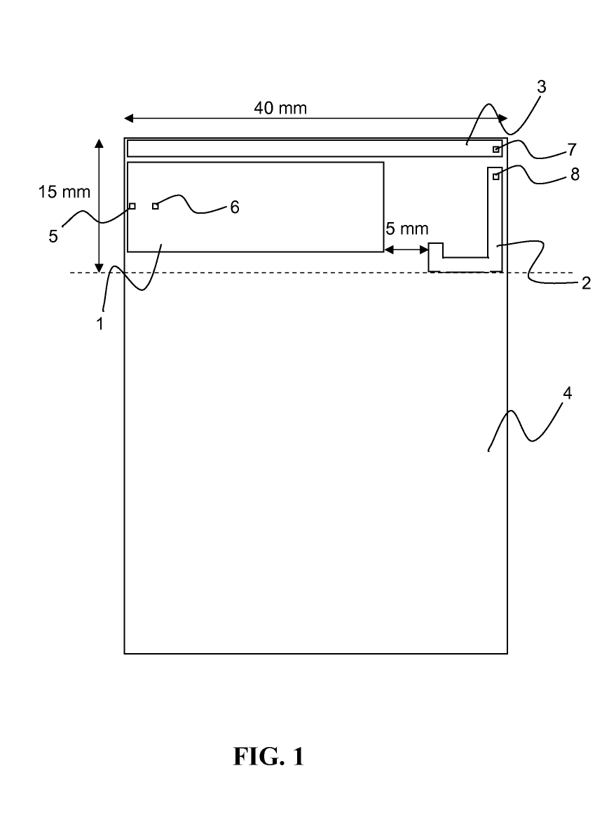

In an exemplary embodiment, an antenna arrangement for a portable radio communication device comprises an NFC antenna, a BT antenna, and an FM antenna. The NFC antenna, the BT antenna, and the FM antenna are positioned in close proximity to each other (e.g., see the exemplary dimensions in millimeters provided in FIGS. 1 through 4, etc.). The NFC antenna, the BT antenna, and the FM are also operable simultaneously. This is feasible in this exemplary embodiment because the NFC antenna is fed through a first decoupling filter and is grounded through a second decoupling filter.

Each of the first and second decoupling filters may preferably comprise a series inductor having an inductance of about 50 nanoHenries (nH) to about 100 nH. In this way, BT is decoupled from the NFC antenna. Each of the first and second decoupling filters may also preferably comprise a further series inductor of about 1000 nH. In this way, FM is decoupled from the NFC antenna.

Advantageously, the antenna arrangement may also comprise a GPS antenna. For efficient utilization of available space, the GPS antenna and BT antenna may preferably have a common radiating element fed through a diplexer. In an alternative solution, the GPS antenna and BT antenna may be preferably arranged on opposite sides of the FM antenna. Also for efficient utilization of available space, the FM antenna may be preferably arranged between the GPS antenna and the NFC antenna.

For good performance of the FM antenna, the FM antenna may be preferably arranged along a top edge of a printed circuit board (PCB) of the portable radio communication device. An advantage of the close proximity of the different antennas is that their radiating elements can all be arranged on a common flex film.

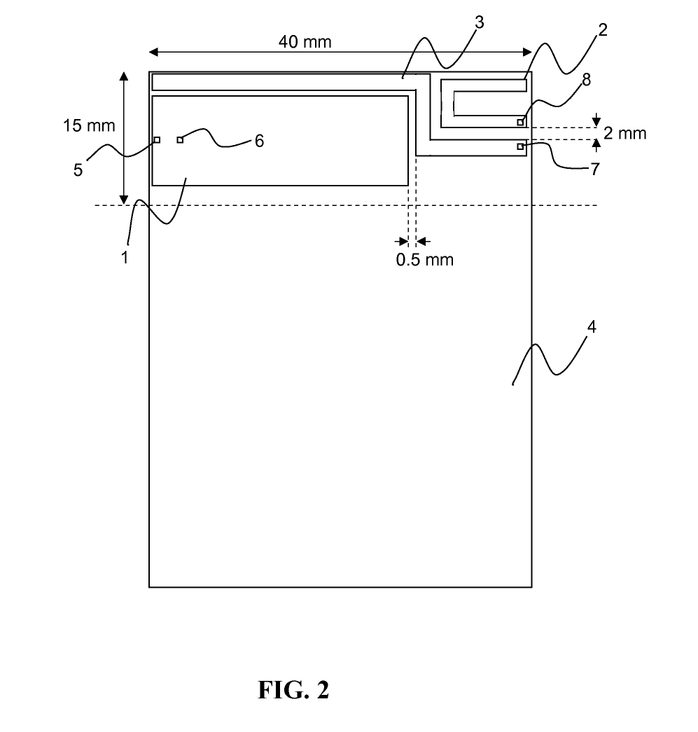

With reference to the figures, FIGS. 1 and 2 illustrate a first exemplary embodiment of an antenna arrangement for a portable radio communication device (e.g., a mobile phone or similar device, etc.). As shown, the antenna arrangement comprises an NFC antenna 1, a BT antenna 2, and an FM antenna 3.

The radiating elements of the three antennas 1, 2, 3 may be provided completely over, partially over or outside a ground plane means of the portable radio communication device. In this illustrated embodiment, the radiating elements are positioned in an on-ground region of a printed circuit board (PCB) corresponding to a position over a ground plane means. Furthermore, the radiating elements may, e.g., be provided as a PIFA, IFA, L-antenna, multi-turn loop antenna, half-loop antenna, or monopole antenna. In this embodiment, the BT antenna 2 is provided as a quarter-wave monopole, the FM antenna 3 is provided as an electrically small monopole, and the NFC antenna 1 is provided as an electrically small multi-turn loop.

The NFC antenna 1, BT antenna 2, and FM antenna 3 are positioned in close proximity to each other and are operable simultaneously. The NFC antenna 1 is fed through a first decoupling filter and is grounded through a second decoupling filter. The FM antenna 3 is fed in a point 7 in the right top corner of the PCB 4 in FIG. 1. The FM antenna 3 has a radiating element extending along essentially the whole length of the top edge of the PCB.

The NFC antenna 1 is fed in a point 5 in an outer part of the multi-turn loop and grounded in a point 6 in an inner part of the multi-turn loop. But the opposite feed/ground point is alternatively possible for the NFC antenna 1. The NFC antenna 1 is arranged adjacent to the FM antenna 3. The BT antenna 2 is fed in a point 8, which is close to the feed point 7 of the FM antenna 2.

The radiating element of the BT antenna 2 extends mainly along the right side edge of the PCB 4 and thereafter extends towards the NFC antenna 1 up to minimum or short distance thereto. In this way, optimal positioning of the FM antenna 3 is achieved and available spacing is provided between the three antennas, e.g., such as for a speaker or a camera.

FIG. 2 illustrates an alternative arrangement of the BT antenna 2 and the FM antenna 3. Here, the FM antenna 3 has a radiating element extending along a major portion of the top edge of the PCB 4, and which continues further down on the PCB 4. The radiating element of the BT antenna 2 extends towards the NFC antenna 1 parallel with the FM antenna 3 and back in a U-shape, positioned upwards of the FM antenna 3. In this way, optimal positioning of the BT antenna 2 is achieved, and available space is utilized for lengthening of the FM antenna 3, e.g., by about 10 millimeters (mm).

Each of the BT-decoupling filters for the NFC antenna feeding and grounding preferably comprises a series inductor. The series inductor preferably has an inductance of about 50-100 nH, which does not affect the NFC antenna performance. In an alternative differential feeding of the NFC antenna, each of the feedings is fed through a BT-decoupling filter. For also FM-decoupling, the decoupling filters preferably comprises a further series inductor of about 1000 nH, but this may be at some expense of NFC antenna performance.

The sizes of the radiating elements for the three antennas may vary. For mounting 5 mm above the ground plane means, the sizes of the radiating elements for the three antennas may be about as follows: NFC antenna 25×10 mm; FM antenna 40×1 mm; BT antenna 20×1 mm.

The FM antenna 3 is designed as an electrically small monopole, and it is mainly sensitive for electrical fields. The NFC antenna 1 is designed as an electrically small multi-turn loop and is mainly sensitive for magnetic fields. Sufficient isolation is achieved between these antennas 1, 3 by a separating distance of at least about 0.5 mm. For further isolation, a further series inductor of 1000 nH may be provided in the decoupling filters, which, however, may be at the expense of NFC performance.

The distance between the radiating element of the FM antenna 3 and the radiating element of the BT antenna 2 should be at least about 2 mm. Further, the open end of the BT antenna 2, having a voltage maximum, is preferably arranged as far from the FM antenna 3 as possible, for maximizing the isolation therebetween. But if the BT antenna 2 is high-pass filtered through, e.g., a 1-2 picoFarad (pF) capacitor, a separating distance of less than 1 mm is sufficient between the BT antenna 2 and the FM antenna 3. Also, the FM antenna 3 preferably comprises a series inductor of about 100 nH blocking BT operation.

Because the NFC antenna 1 is electrically very long at 2.4 Gigahertz (GHz), BT performance would significantly degrade due to the proximity of the NFC performance even at maximum allowed distance between the NFC antenna 1 and the BT antenna 2 within the allocated volume. But this degradation is removed by the BT decoupling inductances mentioned above. The distance between the radiating element of the NFC antenna 1 and the radiating element of the BT antenna 2 should be at least about 5 mm, with utilization of the BT decoupling inductances mentioned above.

An advantage by arranging the feed points 7 and 8 of the FM antenna and the BT antenna, respectively, near each other is that an integrated BT and FM engine module can be utilized.

Although the BT antenna has been described as one of the three antennas, another type of antenna having an operating frequency significantly higher than FM, such as a GPS antenna, can instead be used.

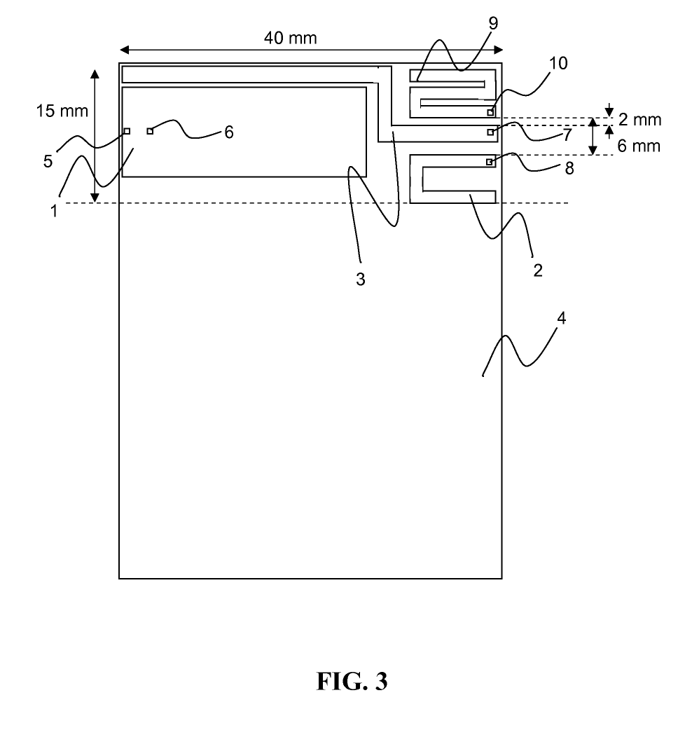

FIG. 3 illustrates an antenna arrangement according to a second embodiment. As shown, the antenna arrangement comprises an NFC antenna 1, a BT antenna 2, an FM antenna 3, and a GPS antenna 9.

The radiating elements of the four antennas may be provided completely over, partially over or outside of a ground plane means of the portable radio communication device. In this embodiment, the radiating elements are positioned in an on-ground region of a printed circuit board (PCB) 4 corresponding to a position over a ground plane means. Furthermore, the radiating elements may, e.g., be provided as a PIFA, IFA, L-antenna, multi-turn loop antenna, half-loop antenna, or monopole antenna. In this embodiment, the BT antenna 2 and GPS antenna 9 are provided as a quarter-wave monopole, the FM antenna 3 is provided as an electrically small monopole, and the NFC antenna 1 is provided as an electrically small multi-turn loop.

The NFC antenna 1, BT antenna 2, GPS antenna 9, and FM antenna 3 are positioned in close proximity to each other and are operable simultaneously. The NFC antenna 1 is fed through a first decoupling filter and is grounded through a second decoupling filter. The NFC antenna 1 is fed in a point 5 in an outer part of the multi-turn loop and grounded in a point 6 in an inner part of the multi-turn loop. But the opposite feed/ground point is alternatively possible for the NFC antenna 1. The NFC antenna 1 is arranged adjacent to the FM antenna 3.

The FM antenna 3 is fed in a point 7 at the right edge of the PCB 4 in FIG. 3. The FM antenna 3 has a radiating element extending along a major portion of the top edge of the PCB 4. The BT antenna 2 is fed in a point 8, close to the feed point 7 of the FM antenna 3. The radiating element of the BT antenna 2 extends towards the NFC antenna 1 mainly parallel to the FM antenna 3. The GPS antenna 9 is fed in a point 10, close to the feed point 7 of the FM antenna 3. The radiating element of the GPS antenna 9 extends partly along the top edge of the PCB 4 and partly facing upwardly on the top side of the PCB 4, making the GPS antenna 9 radiating upwards in a speaking position of a mobile phone.

Each of the decoupling filters for the NFC antenna feeding and grounding comprises a series inductor for BT decoupling. The series inductor preferably has an inductance of about 50-100 nH. In an alternative differential feeding of the NFC antenna, each of the feedings is fed through a decoupling filter. For also FM-decoupling, the decoupling filters preferably comprises a further series inductor of about 1000 nH, but this may come at some expense of NFC antenna performance.

The GPS antenna 9 and BT antenna 2 are arranged on opposite sides of the FM antenna 3 assuring good BT-GPS isolation. The FM antenna 3 is arranged between the GPS antenna 9 and the NFC antenna 1.

The sizes of the radiating elements for the four antennas may vary. For mounting 5 mm above the ground plane means, the sizes of the radiating elements for the four antennas may be about as follows: NFC antenna 25×10 mm; FM antenna 50×1 mm; BT antenna 20×1 mm; GPS antenna 10×5 mm.

The distance between the radiating element of the NFC antenna 1 and the radiating element of the FM antenna 3 should be at least about 0.5 mm. The distance between the radiating element of the NFC antenna 1 and the radiating element of the BT antenna 2 should be at least about 5 mm. The distance between the radiating element of the NFC antenna 1 and the radiating element of the GPS antenna 9 should be at least about 5 mm.

The distance between the radiating element of the FM antenna 3 and the radiating element of the BT antenna 2 should be at least about 2 mm. If the BT antenna 2 is high-pass filtered through, e.g., a 1-2 pF capacitor, a separating distance of less than 1 mm is sufficient between the BT antenna 2 and the FM antenna 3. The distance between the radiating element of the FM antenna 3 and the radiating element of the GPS antenna 9 should be at least about 2 mm.

The distance between the radiating element of the GPS antenna 9 and the radiating element of the BT antenna 2 should be at least about 6 mm. By arranging the FM antenna 3 between the GPS antenna 9 and the BT antenna 2 efficient use of available space is achieved.

An advantage by arranging the feed points 7, 8, and 10 of the FM antenna 3, the BT antenna 2, and the GPS antenna 9, respectively, near each other is that an integrated FM, BT and GPS engine module can be utilized.

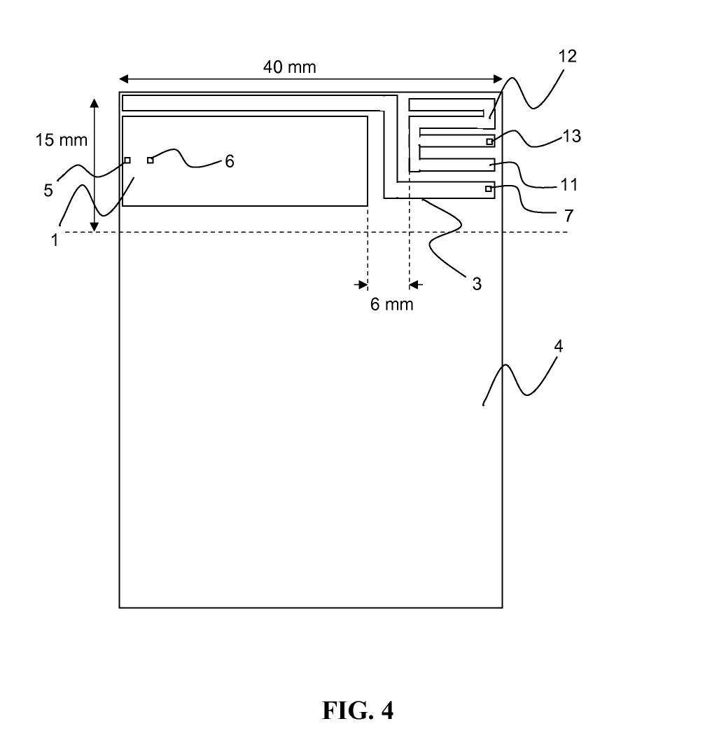

FIG. 4 illustrates an antenna arrangement according to a third embodiment. As shown, the antenna arrangement comprises an NFC antenna 1, a BT antenna 11, an FM antenna 3, and a GPS antenna 12.

The radiating elements of the four antennas may be provided completely over, partially over or outside of a ground plane means of the portable radio communication device. In this embodiment, the radiating elements are positioned in an on-ground region of a printed circuit board (PCB) 4 corresponding to a position over a ground plane means. Furthermore, the radiating elements may, e.g., be provided as a PIFA, IFA, L-antenna, multi-turn loop antenna, half-loop antenna, or monopole antenna. In this embodiment, the BT antenna 11, the GPS antenna 12, and the FM antenna 3 are provided as monopole antennas, and the NFC antenna 1 is provided as a multi-turn loop antenna.

The NFC antenna 1, BT antenna 11, GPS antenna 12, and FM antenna 3 are positioned in close proximity to each other and are operable simultaneously. The NFC antenna 1 is fed through a first decoupling filter and is grounded through a second decoupling filter. The NFC antenna 1 is fed in a point 5 in an outer part of the multi-turn loop and grounded in a point 6 in an inner part of the multi-turn loop. But the opposite feed/ground point is alternatively possible for the NFC antenna 1. The NFC antenna 1 is arranged adjacent to the FM antenna 3.

The FM antenna 3 is fed in a point 7 at the right edge of the PCB 4. The FM antenna 3 has a radiating element extending along a major portion of the top edge of the PCB 4. The FM antenna 3 is arranged between the GPS antenna 12 and the NFC antenna 1 as well as between the BT antenna 11 and the NFC antenna 1. By arranging the FM antenna 3 between the NFC antenna 1 and the BT 11 antenna and between the GPS antenna 12 and the NFC antenna 1, efficient use of available space is achieved.

The BT antenna 11 is fed through a BT/GPS diplexer in a point 13, close to the feed point 7 of the FM antenna 3. The GPS antenna 12 is fed through the BT/GPS diplexer in the point 13 in common with the feed point for the BT antenna 11. The radiating element of the BT antenna 11 extends towards the NFC antenna 1 mainly parallel to the FM antenna 3.

The radiating element of the GPS antenna 12 extends partly along the top edge of the PCB 4 and partly facing upwardly on the top side of the PCB, making the GPS antenna 12 radiating upwards in a speaking position of a mobile phone. The radiating elements of the BT antenna 11 and the GPS antenna 12, respectively, are a common radiating element.

Each of the decoupling filters for the NFC antenna feeding and grounding comprises a series inductor for BT decoupling. The series inductor preferably has an inductance of about 50-100 nH. In an alternative differential feeding of the NFC antenna, each of the feedings is fed through a decoupling filter. For FM decoupling, the decoupling filters preferably comprises a further series inductor of about 1000 nH, but this may come at some expense of NFC performance.

The sizes of the radiating elements for the four antennas may vary. For mounting 5 mm above the ground plane means, the sizes of the radiating elements for the four antennas may be about as follows: NFC antenna 25×10 mm; FM antenna 50×1 mm; BT antenna and GPS antenna 10×10 mm.

The distance between the radiating element of the NFC antenna 1 and the radiating element of the FM antenna 3 should be at least about 0.5 mm. The distance between the radiating element of the NFC antenna 1 and the radiating element of the BT antenna 11 should be at least about 5 mm. The distance between the radiating element of the NFC antenna 1 and the radiating element of the GPS antenna 12 should be at least about 5 mm.

The distance between the radiating element of the FM antenna 3 and the radiating element of the BT antenna 11 should be at least about 2 mm. If the BT antenna 11 is high-pass filtered through, e.g., a 1-2 pF capacitor, a separating distance of less than 1 mm is sufficient between the BT antenna 11 and the FM antenna 3. The distance between the radiating element of the FM antenna 3 and the radiating element of the GPS antenna 12 should be at least about 2 mm.

An advantage by arranging the feed points 7 and 13 of the FM antenna 3, the BT antenna 11, and GPS antenna 12, respectively, near each other is that an integrated FM, BT, and GPS engine module can be utilized.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. An antenna arrangement for a portable radio communication device, comprising an NFC antenna, a BT antenna, and an FM antenna, wherein the NFC antenna, the BT antenna, and the FM antenna are positioned in close proximity to each other and are operable simultaneously, and wherein the NFC antenna is fed through a first decoupling filter and is grounded through a second decoupling filter.

2. The antenna arrangement of claim 1, wherein the first and second decoupling filters each comprises a series inductor.

3. The antenna arrangement of claim 1, wherein the first and second decoupling filters each comprises a series inductor having an inductance of about 50-100 nH.

4. The antenna arrangement of claim 3, wherein the first and second decoupling filters each comprises a further series inductor of about 1000 nH.

5. The antenna arrangement of claim 1, further comprising a GPS antenna.

6. The antenna arrangement of claim 5, wherein:
the GPS antenna and the BT antenna have a common radiating element fed through a diplexer; or
the GPS antenna and the BT antenna are arranged on opposite sides of the FM antenna.

7. The antenna arrangement of claim 5, wherein:
the FM antenna is between the GPS antenna and the NFC antenna; and/or
the FM antenna is between the BT antenna and the NFC antenna; and/or
the FM antenna is between the GPS antenna and the BT antenna.

8. The antenna arrangement of claim 1, wherein:
the distance between a radiating element of the FM antenna and a radiating element the NFC antenna is at least about 0.5 millimeters;
the distance between the radiating element of the FM antenna and a radiating element of the BT antenna is at least about 2 millimeters;
the distance between the radiating element of the BT antenna and the radiating element of the NFC antenna is at least about 5 millimeters;
the distance between the radiating element of the NFC antenna and a radiating element of the GPS antenna is at least about 5 millimeters;
the distance between the radiating element of the FM antenna and the radiating element of the GPS antenna is at least about 2 millimeters; and
the distance between the radiating element of the GPS antenna and the radiating element of the BT antenna is at least about 6 millimeters.

9. The antenna of claim 1, wherein the FM antenna is arranged along an edge of a printed circuit board of the portable radio communication device.

10. The antenna arrangement of claim 1, wherein feed points of the FM antenna and the BT antenna distanced from feed points of the NFC antenna.

11. The antenna arrangement of claim 1, wherein:
the BT antenna comprises a quarter-wave monopole antenna;
the FM antenna comprises an electrically small monopole antenna; and
the NFC antenna comprises an electrically small multi-turn loop antenna.

12. The antenna arrangement of claim 1, wherein:
the distance between a radiating element of the FM antenna and a radiating element of the NFC antenna is at least about 0.5 millimeters;
the distance between the radiating element of the FM antenna and a radiating element of the BT antenna is at least about 2 millimeters; and
the distance between the radiating element of the BT antenna and the radiating element of the NFC antenna is at least about 5 millimeters.

13. The antenna arrangement of claim 1, wherein:
the BT antenna is high-pass filtered, such that a separating distance of less than 1 millimeters is sufficient between the FM antenna and the BT antenna; and/or the BT antenna includes an open end arranged farthest far from the FM antenna as possible, for maximizing isolation therebetween; and/or
the FM antenna comprises a series inductor of about 100 nH operable for blocking BT operation.

14. A portable radio communication device comprising the antenna arrangement of claim 1.

15. A portable radio communication device comprising an NFC antenna, a BT antenna, and an FM antenna, wherein the NFC antenna, the BT antenna, and the FM antenna are positioned in close proximity to each other and are operable simultaneously, and wherein the NFC antenna is fed through a first decoupling filter and is grounded through a second decoupling filter.

16. The portable radio communication device of claim 15, wherein:
the first and second decoupling filters each comprises a series inductor;
the BT antenna comprises a quarter-wave monopole antenna;
the FM antenna comprises an electrically small monopole antenna arranged along an edge of a printed circuit board of the portable radio communication device;
the NFC antenna comprises an electrically small multi-turn loop antenna;
the distance between a radiating element of the FM antenna and a radiating element of the NFC antenna is at least about 0.5 millimeters;
the distance between the radiating element of the FM antenna and a radiating element of the BT antenna is at least about 2 millimeters; and
the distance between the radiating element of the BT antenna and the radiating element of the NFC antenna is at least about 5 millimeters.

17. The portable radio communication device of claim 15, further comprising a GPS antenna.

18. The portable radio communication device of claim 17, wherein:
the FM antenna is between the GPS antenna and the NFC antenna; and/or
the FM antenna is between the BT antenna and the NFC antenna; and/or
the FM antenna is between the GPS antenna and the BT antenna.

19. The portable radio communication device of claim 17, wherein:
the GPS antenna and the BT antenna have a common radiating element fed through a diplexer; and/or
the GPS antenna and the BT antenna are arranged on opposite sides of the FM antenna.

20. The portable radio communication device of claim 17, wherein:
the distance between a radiating element of the FM antenna and a radiating element the NFC antenna is at least about 0.5 millimeters;
the distance between the radiating element of the FM antenna and a radiating element of the BT antenna is at least about 2 millimeters;
the distance between the radiating element of the BT antenna and the radiating element of the NFC antenna is at least about 5 millimeters;
the distance between the radiating element of the NFC antenna and a radiating element of the GPS antenna is at least about 5 millimeters;
the distance between the radiating element of the FM antenna and the radiating element of the GPS antenna is at least about 2 millimeters; and
the distance between the radiating element of the GPS antenna and the radiating element of the BT antenna is at least about 6 millimeters.
